(19) United States
(12) Patent Application Publication
(10) Pub. No.: US 2008/0083088 A1
(43) Pub. Date: Apr. 10, 2008

(54) Door hinge structure

(75) Inventor: Ching-Yi Lin, Changhua Hsien (TW)

Correspondence Address: RABIN & Berdo, PC, 1101 14TH STREET, NW, SUITE 500, WASHINGTON, DC, 20005, US

(73) Assignee: Lin Kun Ta Industrial Co., Ltd., Changhua Hsien (TW)

(21) Appl. No.: 11/543,844

(22) Filed: Oct. 6, 2006

(51) Int. Cl. E05D 11/10

(52) U.S. Cl. 16/327

(57) ABSTRACT

A door hinge structure includes a turning body and a fixing body installed respectively at upper and lower lateral positions of a door plank and a door frame, and the turning body and the fixing body are pivotally coupled by an axial bolt, such that the resilience of a transversal long spring coil installed in the turning body can be enhanced to achieve the effects for installing the door plank successfully in a one-time construction and quickly resuming the door plank to its closed position.

### BACKGROUND OF THE INVENTION

1. Field of the Invention

The present invention relates to a door hinge structure, and more particularly to a door hinge structure that includes a turning body and a fixing body respectively installed at upper and lower lateral positions of a door plank and a door frame, and the turning body and the fixing body are pivotally coupled by an axial bolt, so as to achieve the effects of installing the door plank successfully at one time and resuming the door plank quickly to its closed position.

2. Description of the Related Art

In general, a door plank is mounted onto a door frame by installing a hinge module separately at upper and lower positions of the door frame for opening or closing the door plank. To achieve the effect of resuming a closed position after the door plank is opened, an automatic door closing device is usually installed, so that the reaction of the automatic door closing device will return the opened door plank to its original position. Although such arrangement is effective, it requires the installation of an automatic door closing device. Furthermore, the automatic door closing device is installed after the hinges of the door plank are installed, and thus it takes the time for performing a “two-time construction”. Finding a way of achieving the same effect by using a “one-time construction” not only saves time, but also lowers costs, which are definitely advantageous to consumers.

### SUMMARY OF THE INVENTION

In view of the foregoing shortcomings of the present invention, the inventor of the present invention based on years of experience on the related field to conduct extensive experiments and modifications and finally developed a door hinge structure in accordance with the present invention.

Therefore, it is a primary objective of the present invention to overcome the shortcomings of the prior art by providing a door hinge structure that comprises a turning body and a fixing body respectively installed at upper and lower lateral positions of a door plank and a door frame, and the turning body and the fixing body are pivotally coupled by an axial bolt, wherein two protrusions disposed on the fixing body separately have a hollow penetrating hole, and the protrusion has a parallel transversal screw thread hole disposed thereon and penetrated through an inner edge of the penetrating hole for an interconnection. The protrusion at an end of the turning body has a hollow penetrating hole, and the turning body has a plurality of transversal screw holes disposed thereon for installing and combining a protruding bolt, a long spring coil, and a rotary screw bolt. Further, the axial bolt has a sunken surface separately disposed at a position facing upper and lower positions of the fixing body, and a plurality of tilted sunken grooves disposed at the middle position facing the turning body for adjusting the opening angle of the door plank, such that the sunken surfaces disposed on both upper and lower ends of the axial bolt are in contact with the long screw bolt that is screwed into the thread hole of the fixing body, and the sunken groove disposed at the middle of the axial bolt props the protruding bolt by the resilience of the long spring coil, such that the resilience of a transversal long spring coil installed in the turning body can be enhanced to achieve the effects for installing the door plank successfully in a one-time construction and quickly resuming the door plank to its closed position.

### BRIEF DESCRIPTION OF THE DRAWINGS

FIG. 1A is a schematic view of an installing position of the present invention;

FIG. 1B is a schematic enlarged view of an assembly of the present invention;

FIG. 2A is an exploded view of a structure of the present invention;

FIG. 2B is another exploded view of a structure of the present invention;

FIG. 3 is a perspective view of a structure of the present invention;

FIG. 4 is a schematic view of opening a door plank of the present invention;

FIG. 5 is a schematic view of a closing movement of the present invention; and

FIG. 6 is a schematic view of closing a door plank of the present invention.

### DETAILED DESCRIPTION OF THE PREFERRED EMBODIMENTS

The above and other objects, features and advantages of the present invention will become apparent from the following detailed description taken with the accompanying drawing.

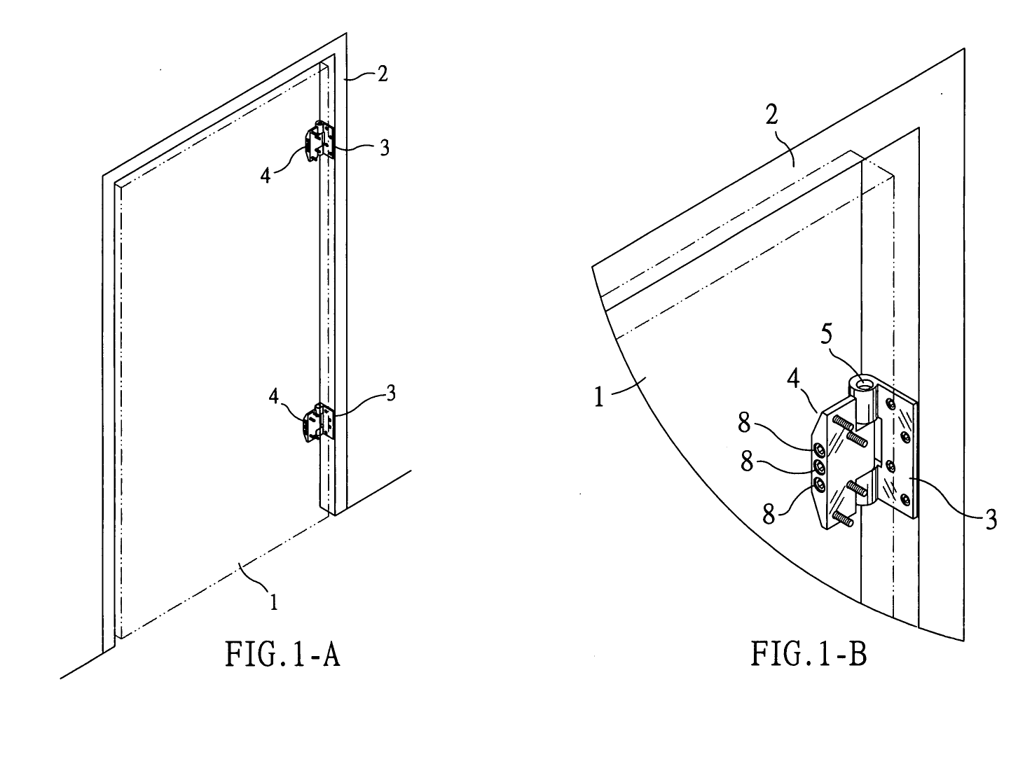

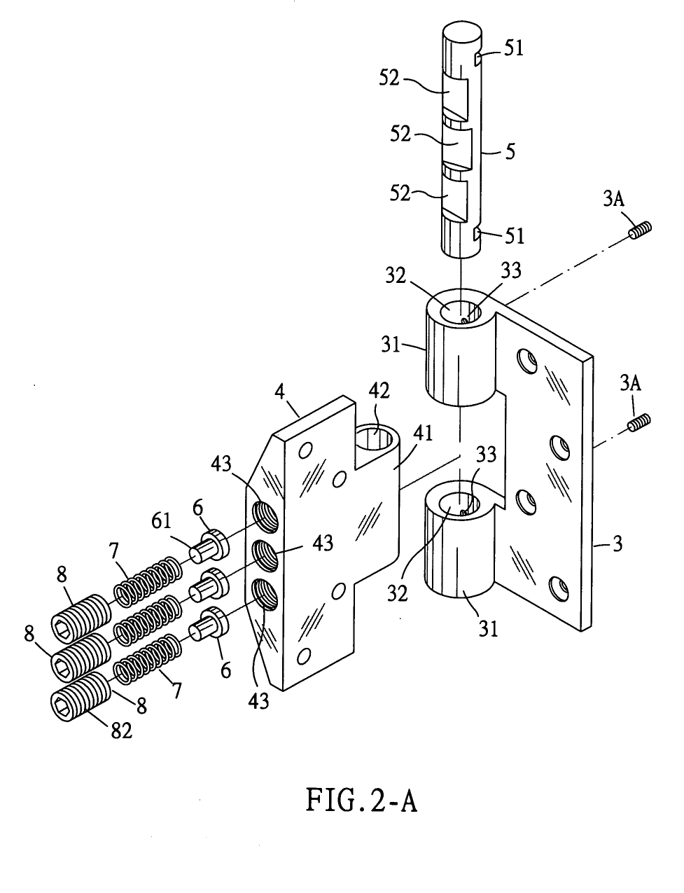

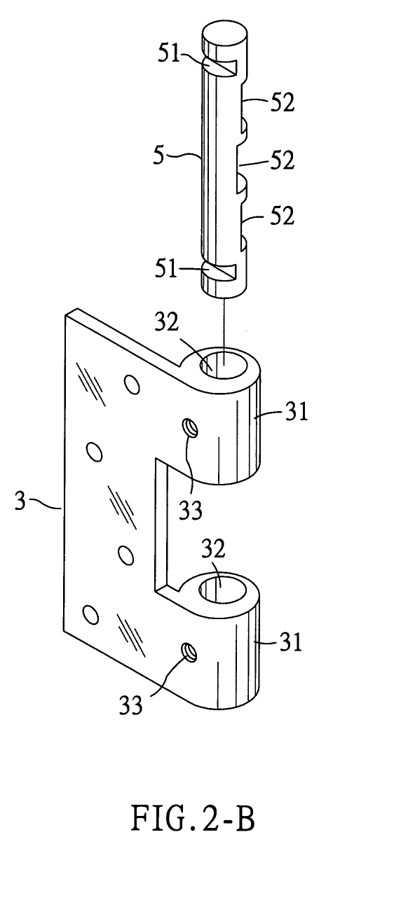

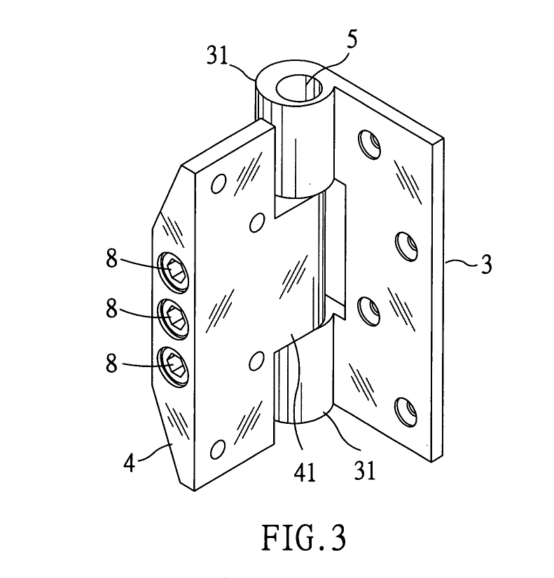

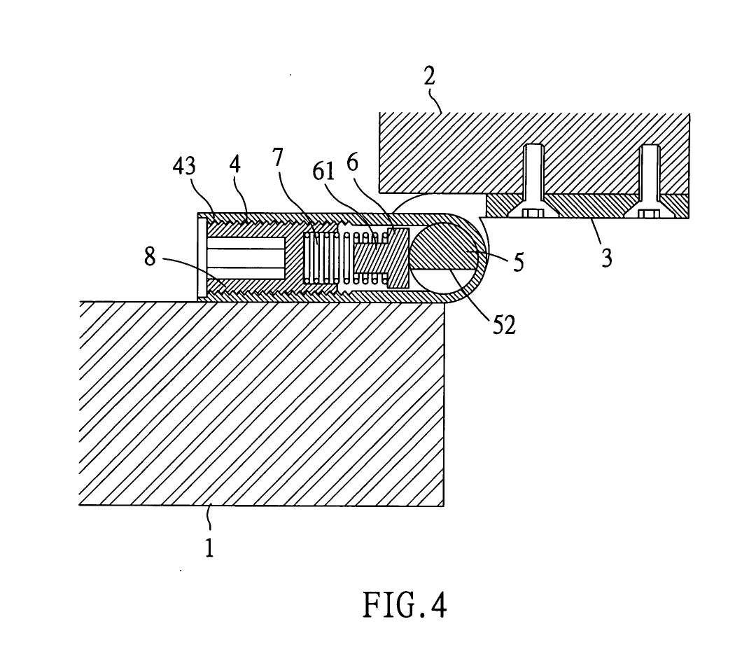

Referring to FIGS. 1A, 1B and 2A for the detailed description of the present invention, a door hinge structure of the invention comprises a turning body 4 and a fixing body 3 respectively installed at upper and lower lateral positions of a door plank 1 and a door frame 2, and the turning body 4 and the fixing body 3 are pivotally coupled by an axial bolt 5. Two protrusions 31 on the fixing body 3 separately have a hollow penetrating hole 32, and the protrusion 31 has a parallel transversal screw thread hole 33 penetrated into an inner edge of the penetrating hole 32 for an interconnection. A protrusion 41 on the turning body 4 has a vertical hollow penetrating hole 42, and the turning body 4 has a plurality of transversal screw holes 43 disposed thereon for installing and combining a protruding bolt 6, a long spring coil 7 and a rotary screw bolt 8. Further, an axial bolt 5 has a sunken surface 51 separately disposed at upper and lower positions of the fixing body 3, and a plurality of tilted sunken grooves 52 are disposed at positions facing the middle of the turning body 4. Both ends of the long spring coil 7 are clamped and coupled by a protruding center 61 of the protruding bolt 6 and an indent 81 in the rotary screw bolt 8, and an external screw thread 82 disposed on an external surface of the rotary screw bolt 8 is screwed with a screw hole 43 disposed on the turning body 4 for adjusting the resilience of the long spring coil 7, such that after two sets of turning bodies 4 and fixing bodies 3 are installed respectively at upper and lower lateral positions of the door plank 1 and the door frame 2, and the protrusion 41 of the turning body 4 is embedded between two protrusions 31 of the fixing body 3, the penetrating holes 32, 42 can be provided for passing the axial bolt 5 (as shown in FIG. 3), and the sunken surfaces 51 on both upper and lower ends of the axial bolt 5 are in contact with the long screw bolt 3A through the screw thread hole 33 of the fixing body 3, and a tilted sunken groove 52 disposed at the middle of the axial bolt 5 props the protruding bolt 6 by means of the resilience of the long spring coil 7 (as shown in FIG. 4), so as to adjust the opening angle of the door plank 1.

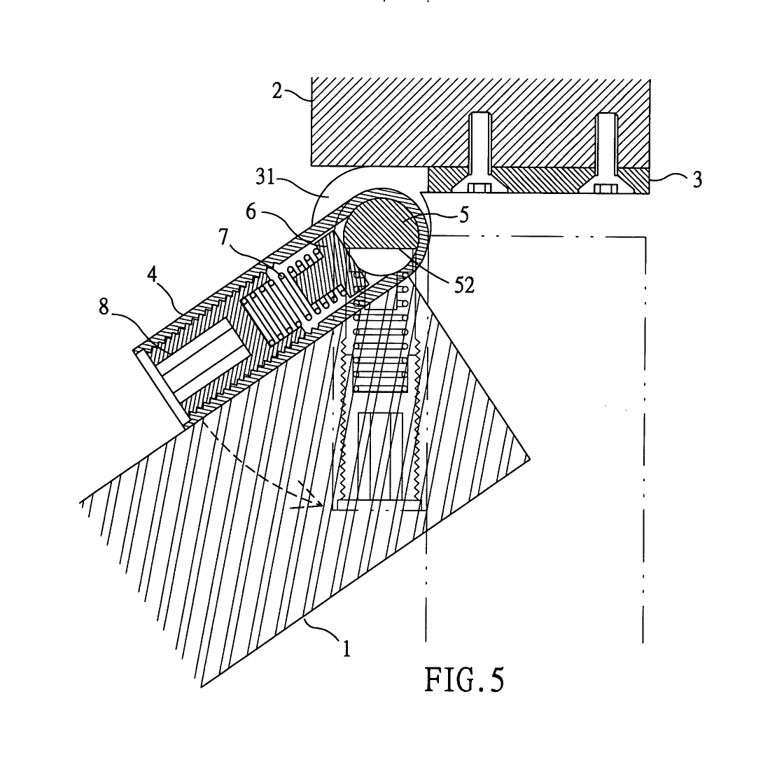

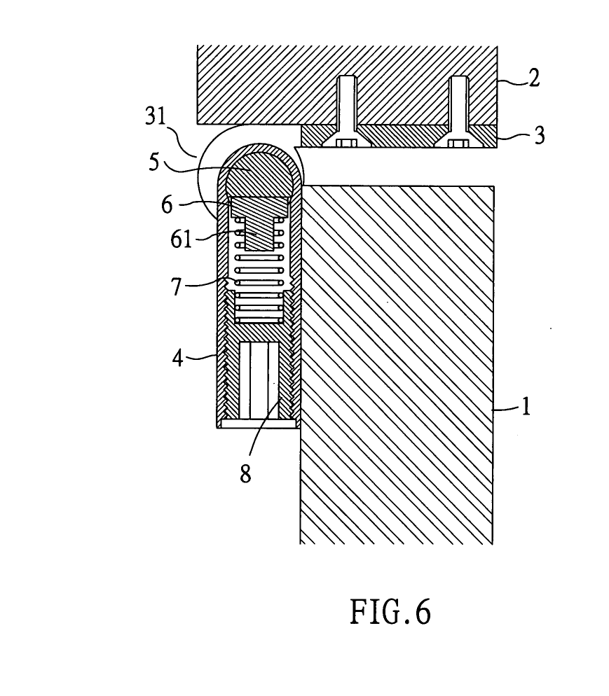

If the door plank 1 and the door frame 2 are installed with the turning body 4 and the fixing body 3 respectively and the turning body 4 and the fixing body 3 are coupled by an axial bolt 5 (as shown in FIGS. 1A and 1B), the length of the long spring coil 7 installed in the transversal screw hole 43 of the turning body 4 will be increased to enhance the resilience. After the door plank 1 is pushed open (as shown in FIG. 4), a push in an opposite direction resumes the door plank 1 to its closed position (as shown in FIGS. 5 and 6), and thus the installed structure of the present invention can overcome the inconvenience of the traditional “two-time construction” of the hinge and automatic door closing device by adopting a “one-time construction” and save time and costs.

In summation of the above description, the present invention definitely achieves the expected objective and provides an improved structure to enhance the performance over the prior art. The invention further complies with the patent application requirements and is duly filed for the patent application.

What is claimed is:

1. A door hinge structure, comprising a turning body and a fixing body installed respectively to upper and lower lateral positions of a door plank and a door frame, wherein said turning body and said fixing body are pivotally coupled by an axial bolt, characterized in that:
said fixing body includes a hollow penetrating hole disposed on two protrusions and a parallel transversal screw thread hole disposed thereon and penetrated through an inner edge of said penetrating hole for an interconnection;
said turning body includes a vertical hollow penetrating hole disposed at an end of said protrusion, a plurality of transversal screw holes disposed on said turning body for installing and combining a protruding bolt, a long spring coil, and a rotary screw bolt;
and both ends of said long spring coil are clamped and coupled by a protruding center of said protruding bolt and an indent in said rotary screw bolt, and an external screw thread on an external surface of said rotary screw bolt is screwed with a screw hole on said turning body for adjusting the resilience of the long spring coil; and
said axial bolt includes a sunken surface separately disposed at upper and lower positions facing said fixing body, and a tilted sunken groove disposed at a position facing the middle of said turning body for adjusting an opening angle of said door plank;
thereby, the resilience of said transversal long spring coil installed in said turning body is enhanced to achieve the effects of installing said door plank by a one-time construction and resuming said door plank quickly to its closed position.
